(19) United States
(12) Patent Application Publication
(10) Pub. No.: US 2011/0244262 A1
(43) Pub. Date: Oct. 6, 2011

(54) Metal Bonding Member and Fabrication Method of the Same

(75) Inventors: Keishi SATO, Yokohama (JP); Shosaku ISHIHARA, Chigasaki (JP); Kazuaki NAOE, Fujisawa (JP)

(73) Assignee: Hitachi, Ltd., Tokyo (JP)

(21) Appl. No.: 12/952,911

(22) Filed: Nov. 23, 2010

(30) Foreign Application Priority Data
Mar. 31, 2010 (JP) 2010-080110

(51) Int. Cl. B23K 35/14; B05D 5/10; B05D 3/00

(52) U.S. Cl. 428/576; 427/207.1; 427/600

(57) ABSTRACT

Provided are a metal bonding member having both a high adhesion strength and an excellent heat cycle reliability and a fabrication method of the same. A metal bonding member has a solder layer formed on at least a part of the surface of a metal substrate. The metal bonding member has an adhesion layer formed of metal particles having an excellent wettability with the solder layer in the interface between the solder layer and the metal substrate. The adhesion layer is partially buried in the metal substrate to form an anchor layer.

This application claims the priority of Japanese application no. 2010-080110, filed Mar. 31, 2010, the disclosure of which is expressly incorporated by reference herein.

### BACKGROUND OF THE INVENTION

1. Field of the Invention

The present invention relates to a metal bonding member and a fabrication method of the same.

2. Description of the Related Arts

There is solder joint for one of methods of bonding metal substrates. Solder joint is a technique that can facilitate the bonding of different kinds of metal substrates to each other at low temperature without melting these metal substrates. This technique is used for many purposes because metal substrates are not deformed due to heat and thermal energy necessary for bonding is small.

However, in order to select a solder and a metal substrate to be bonded, it is necessary to consider wettability between the solder and the metal substrate. For example, conventionally, for one of techniques of bonding aluminum materials, there is solder joint using Zn—Al and Zn—Sn alloys having an excellent wettability with aluminum materials. However, Zn—Al solders have a melting point as high as 623 K, which have a problem in that it is unable to carry out solder joint at low temperature. Further, although Sn—Zn solders described in Japanese Patent Application Laid-Open Publication No. H10-278558 have a melting point as low as about 473 K, they are oxidizable in the atmosphere. On this account, there is a problem in that bonding defects tend to occur because of the oxidized solder surface during solder joint formation.

In other words, once a material for a metal substrate is selected, it is inevitable to select a solder having a good wettability with this material even though this choice is not suited in terms of an environment in which a metal bonding member is used, or the like, causing various problems.

### SUMMARY OF THE INVENTION

The present invention has been made in view of the above-mentioned problems. It is an object of the present invention is to provide a metal bonding member having both a high adhesion strength and an excellent temperature cycling reliability even for metal substrates having a poor solder wettability.

The following is a brief summary of representative aspects disclosed in the present application.

In the present invention, in fabricating a metal bonding member, an adhesion layer and a solder layer are provided at least on a part of the surface of a metal substrate in order from the metal substrate. The adhesion layer is a deposition layer of adhesion particles made of a metal having an excellent wettability with solder. The adhesion particles are partially buried in the metal substrate. Furthermore, the bonding interface between the adhesion layer and the solder layer is in an uneven shape.

According to the metal bonding member of the present invention, bonding between the metal substrate to the adhesion layer has a high adhesion strength due to anchor effect by partially buying the adhesion particles in the metal substrate. Also, because the bonding interface between the adhesion layer and the solder layer is in an uneven shape, cracks caused by thermal stress or the like do not tend to be developed, and a high temperature cycling reliability is provided.

Further, the present invention is a metal bonding member including: a metal substrate; an adhesion layer formed on the metal substrate, wherein the adhesion layer contains a plurality of metal particles made of a material different from that of the metal substrate, and the plurality of metal particles are partially buried in a surface of the metal substrate; and a solder layer formed on the adhesion layer.

Furthermore, the present invention is a fabrication method of a metal bonding member, including the steps of: forming an adhesion layer containing a plurality of metal particles, the plurality of metal particles being partially buried in a metal substrate, by colliding, against the metal substrate, the plurality of metal particles having a material different from that of the metal substrate such that the plurality of metal particles are partially buried in a surface of the metal substrate; and forming a solder layer on the adhesion layer formed on the metal substrate.

A metal bonding member having both a high adhesion strength and an excellent temperature cycling reliability can be provided. In particular, a bonding member including a metal having a poor solder wettability can also be provided.

### BRIEF DESCRIPTION OF THE DRAWINGS

The present invention will become fully understood from the detailed description given hereinafter and the accompanying drawings, wherein:

FIG. 1 is a schematic cross sectional view depicting a metal bonding member according to a first embodiment of the present invention;

FIGS. 2A to 2F are schematic diagrams depicting the fabrication process steps of the metal bonding member according to the first embodiment of the present invention;

FIG. 3 is a schematic cross sectional view depicting a metal bonding member according to a second embodiment of the present invention; and

FIGS. 4A to 4C are schematic diagrams depicting the fabrication process steps of the metal bonding member according to the second embodiment of the present invention.

### DETAILED DESCRIPTION OF THE PREFERRED EMBODIMENTS

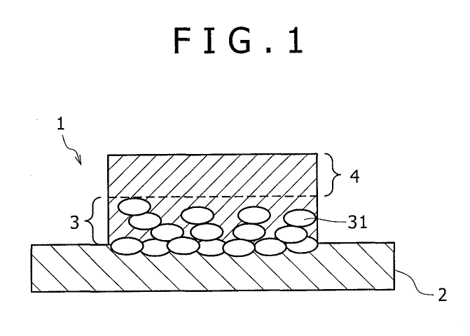

A first embodiment of a metal bonding member according to the present invention will be described with reference to FIG. 1.

A metal bonding member 1 of this embodiment is formed to have a plate-shaped metal substrate 2 made of Al, an adhesion layer 3 formed on the metal substrate 2, the adhesion layer 3 including a plurality of Cu adhesion particles 31 partially buried in the metal substrate 2 and a Sn—Cu solder phase, and an Sn—Cu solder layer 4 formed on the adhesion layer 3.

Now, as shown in FIG. 1, in the adhesion layer 3, the plurality of Cu adhesion particles 31 are deposited on the surface bonded to the metal substrate 2, and the plurality of Cu particles are partially buried in the metal substrate 2 in the interface therebetween. On this account, an excellent adhesion strength can be obtained between the adhesion layer 3 and the metal substrate 2 due to anchor effect. Further, because the adhesion layer 3 has the solder phase on the surface to be bonded to the solder layer 4, an excellent adhesion strength is also provided between the adhesion layer 3 and the solder layer 4. Furthermore, in the adhesion layer 3, the Sn—Cu solder phase having a good wettability enters among a plurality of Cu particles, the interfaces of which are in uneven shapes because of their deposition, as well as the strength due to anchor effect is also provided. Consequently, such a bonding member is implemented that has both a high adhesion strength and a high temperature cycling reliability as the entire metal bonding member 1.

As discussed above, with the metal bonding member according to this embodiment, connections to various solder materials, such as lead-free solders having low melting points and lead-free solders having high melting points, are freely allowed according to purposes for use by properly selecting particles for the adhesion layer 3 and the solder layer 4, without any limitations in combinations of metal substrates and solder materials, which are conventionally restricted in terms of solder wettability (for example, Zn—Al or Zn—Sn solders for Al substrates).

Further, in this embodiment, the case of the metal substrate 2 made of Al is shown. However, a metal substrate may be made of Al alloys, or may be made of other metals having a poor solder wettability. Furthermore, in this embodiment, the case of the adhesion particles 31 made of Cu is shown. However, metal particles may be made of Cu alloys, Ni, Ni alloys, or proper combinations thereof. Such materials may be properly selected that are different from the material of the metal substrate and harder than the metal substrate and have a good wettability with solder. Additionally, materials used for the solder layer 4 may be those having a good wettability with the particles 31. For example, in the case of Cu particles, low melting point solders such as Sn—Ag—Cu solders can be used in addition to Sn—Cu solders, and solder materials can be properly selected according to particle materials.

Further, in this embodiment, the case is shown as an example in which the adhesion layer 3 and the solder layer 4 are formed on a part of one surface of the plate-shaped metal substrate 2. However, there are no limitations to this. These layers may be formed on throughout the surface or may be formed on both front and back surfaces. Furthermore, the shape of the metal substrate 2 is not limited to a plate shape. Various shapes such as foil or blocks can be properly selected according to the use forms of the metal bonding member 1.

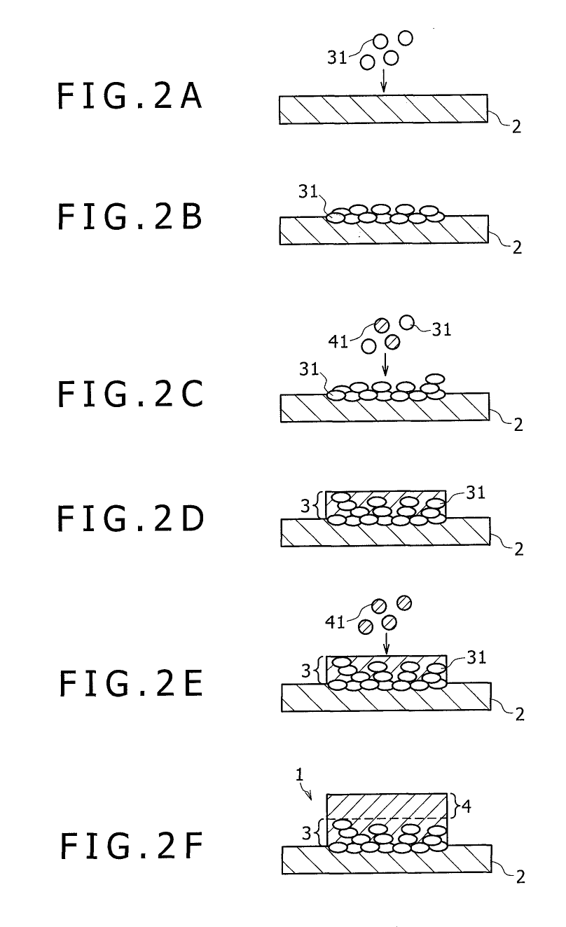

Next, a fabrication method of the above-described metal bonding member according to the first embodiment will be described with reference to FIGS. 2A to 2F. In addition, the shape of the metal substrate and materials for the particles and the solder layer can be properly selected as discussed above, which are not restricted to the following descriptions.

First, powder of the adhesion particles 31 is collided against the surface of the metal substrate 2 at high speed using particle impaction deposition typified by aerosol deposition and cold spray (FIG. 2A), and a plurality of the particles are deposited such that these particles are at least partially buried in the surface of the metal substrate 2 (FIG. 2B). As described above, high speed collision of powder of the adhesion particles 31 against the Al metal substrate 2 removes the oxide film on the Al surface by abrasion effect to produce coupling between the new surfaces of the Al substrate and the adhesion particles 31 as well as partially buries the adhesion particles 31 in the Al substrate. Consequently, a highly excellent adhesion strength can be obtained.

Subsequently, a powder mixture of the adhesion particles 31 and solder particles 41 are collided at high speed by the above-mentioned scheme (FIG. 2C), and then the adhesion layer 3 is formed, in which the interfaces of the deposited particles form in uneven shapes and the solder phase of the solder particles 41 enters among the particles (FIG. 2D). Here, the ratio between the adhesion particles 31 and the solder particles 41 may be constant during the above-mentioned impaction deposition process, or the ratio of the solder particles 41 may be gradually increased. Furthermore, the ratio may be changed in such a way that the ratio of the adhesion particles 31 is temporarily reduced in order to obtain the anchor effect, and the ratio is again increased and then decreased. These ratios can be properly varied in units of processing time periods.

Subsequently, only the solder particles 41 are collided at high speed by the scheme similar to the above-mentioned scheme (FIG. 2E), and then the solder layer 4 is formed. Consequently, the metal bonding member 1 can be fabricated (FIG. 2F).

Further, desirably, an atmospheric condition for forming the adhesion layer 3 and the solder layer 4 is a non-oxidation atmosphere. This is because when oxide components are included between the bonding interfaces among the metal substrate 2, the adhesion particles 31, and the solder particles 41 during the fabrication of metal bonding members, voids are produced in the bonding interfaces during solder joint formation, causing a decrease in adhesion strength.

Furthermore, desirably, the atmospheric temperature, at which the adhesion layer 3 and the solder layer 4 are formed, is equal to or below the melting point of the adhesion particles. This is because when the atmospheric temperature is higher than the melting point of the adhesion particles, solution reactions tend to occur between the adhesion particles and the solder particles, and the interface between the adhesion layer 3 and the solder layer 4 does not tend to form in an excellent uneven shape.

The aluminum bonding member obtained by the above-mentioned fabrication method can be bonded to other members by Sn—Ag—Cu or Sn—Cu solder joint.

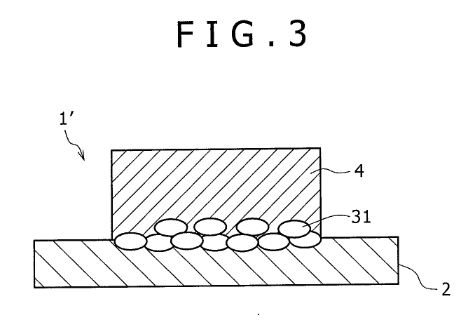

Next, a second embodiment of the metal bonding member according to the present invention will be described with reference to FIG. 3. In addition, the basic configuration of the second embodiment is similar to that of the first embodiment. The same components are designated the same numerals and signs for omitting the explanation, and the differences from the first embodiment will be mainly described below.

A metal bonding member 1′ according to the second embodiment is configured to include a plate-shaped metal substrate 2 made of Al, an adhesion layer 3′ formed on the metal substrate 2, the adhesion layer 3′ including a plurality of Cu adhesion particles 31 partially buried in the metal substrate 2, and an Sn—Cu solder layer 4 formed on the adhesion layer 3′.

The difference between the second embodiment and the first embodiment is in that the adhesion layer 3 is formed only of Cu particles. Accordingly, the interfaces of the plurality of Cu particles forming the adhesion layer 3 do not form in uneven shapes as in the first embodiment, and the adhesion strength and the temperature cycling reliability as those in the first embodiment are not obtained. However, as described later, according to this embodiment, because it is unnecessary to use particle impaction deposition for forming the solder layer 4, versatility is increased since broader options are available for the materials of the solder layer 4.

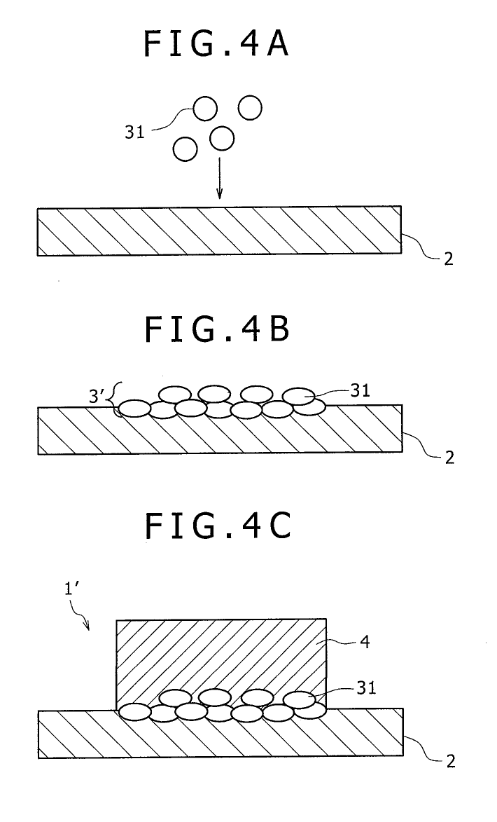

A fabrication method of the metal bonding member according to the second embodiment will be described with reference to FIGS. 4A to 4C. First, as similar to the steps shown in FIGS. 2A and 2B, powder of the adhesion particles 31 is collided against the surface of the metal substrate 2 at high speed using particle impaction deposition typified by aerosol deposition and cold spray (FIG. 4A), and a plurality of the particles are deposited such that the particles are at least partially buried in the metal substrate 2 for forming the adhesion layer 3′ (FIG. 4B). After that, the solder layer 4 is formed on the metal substrate 2 having the adhesion layer 3′ formed thereon by properly using a process such as paste printing or ultrasonic bonding other than particle impaction deposition. Consequently, the metal bonding member 1′ can be fabricated (FIG. 4C).

According to this fabrication method, because it is unnecessary to use particle impaction deposition for producing the solder layer 4, it is made possible that fabrication process steps are accelerated, that broader options are available for the materials of the solder layer 4, and that the thickness of the solder layer 4 is thickened as necessary.

In the metal bonding member and the fabrication method of the same according to the above-mentioned second embodiment, the plate-shaped Al metal substrate and the Cu particles are taken and described as an example. However, shapes and materials are not restricted to these. The shapes and materials described in the first embodiment may be properly selected and used.

As discussed above, the invention made by the present inventors has been specifically described based on the embodiments. It is needless to say that the present invention is not restricted to the above-mentioned embodiments, which can be modified variously within the scope of the teachings thereof. According to the present invention, a metal bonding member having both a high adhesion strength and an excellent temperature cycling reliability can be provided even for metal substrates having a poor solder wettability in particular.

What is claimed is:

1. A metal bonding member comprising:
a metal substrate;
an adhesion layer formed on the metal substrate, the adhesion layer containing a plurality of metal particles made of a material different from that of the metal substrate, and the plurality of metal particles being partially buried in a surface of the metal substrate; and
a solder layer formed on the adhesion layer.

2. The metal bonding member according to claim 1,
wherein the adhesion layer further contains a solder phase having a material the same as that of the solder layer.

3. The metal bonding member according to claim 2,
wherein the solder phase partially enters between the plurality of metal particles.

4. The metal bonding member according to claim 2,
wherein an interface between the solder phase and the plurality of metal particles is in an uneven shape.

5. The metal bonding member according to claim 1,
wherein: the plurality of metal particles are made of Cu, a Cu alloy, or a combination thereof; and
the solder layer is made of an Sn—Cu solder or an S—Ag—Cu solder.

6. The metal bonding member according to claim 1,
wherein the plurality of metal particles are made of Ni, an Ni alloy, or a combination thereof.

7. The metal bonding member according to claim 1,
wherein the metal substrate is made of Al or an Al alloy.

8. A fabrication method of a metal bonding member, comprising the steps of:
forming an adhesion layer containing a plurality of metal particles, the plurality of metal particles being partially buried in a metal substrate, by colliding, against the metal substrate, the plurality of metal particles having a material different from that of the metal substrate such that the plurality of metal particles are partially buried in a surface of the metal substrate; and
forming a solder layer on the adhesion layer formed on the metal substrate.

9. The fabrication method of a metal bonding member according to claim 8, wherein the step of forming the adhesion layer includes:
a first step of colliding the plurality of metal particles; and
a second step of colliding a powder mixture of the plurality of metal particles and solder particles.

10. The fabrication method of a metal bonding member according to claim 9, wherein in the step of forming the adhesion layer, a material the same as that of the solder layer is used for the solder particles.

11. The fabrication method of a metal bonding member according to claim 8, wherein in the step of forming the solder layer, the solder layer is formed by paste printing and ultrasonic bonding.

12. The fabrication method of a metal bonding member according to claim 8,
wherein: in the step of forming the adhesion layer, Cu, a Cu alloy, or a combination thereof is used for the metal particles; and
in the step of forming the solder layer, an Sn—Cu solder or an Sn—Ag—Cu solder is used.

13. The fabrication method of a metal bonding member according to claim 8, wherein, in the step of forming the adhesion layer, Ni, an Ni alloy, or a combination thereof is used for the metal particles.

14. The fabrication method of a metal bonding member according to claim 8, wherein, in the step of forming the adhesion layer, the plurality of metal particles are collided against the metal substrate by aerosol deposition or cold spray.
